(19) United States
(12) Patent Application Publication
(10) Pub. No.: US 2024/0149269 A1
(43) Pub. Date: May 9, 2024

(54) METHOD OF REVERSE TRANSCRIPTION REACTION WITHIN A FLOWING LIQUID

(71) Applicant: Nucleic Sensing Systems, LLC, Saint Paul, MN (US)

(72) Inventor: Cody Youngbull, Arlington, VA (US)

(21) Appl. No.: 18/500,425

(22) Filed: Nov. 2, 2023

Related U.S. Application Data
(60) Provisional application No. 63/422,160, filed on Nov. 3, 2022.

(51) Int. Cl. B01L 7/00

(52) U.S. Cl. CPC B01L 7/52

(57) ABSTRACT

A thermal manifold structured and configured to maintain a temperature profile required to perform a reverse transcription reaction within a flow channel having a liquid contained therein. In some embodiments, the reverse transcription reaction may occur while the liquid is in a laminar flow regime within the flow channel. The thermal manifold may include an integral flow channel, or a flow channel with a Teflon tube contained therein. Additionally, the placement of the thermal manifold may vary within a continuous-flow emulsion droplet reactor system.

### STATEMENT REGARDING FEDERALLY SPONSORED RESEARCH OR DEVELOPMENT

This invention was made with government support under NA21OAR0210295 awarded by National Oceanic and Atmospheric Administration. The government has certain rights in the invention.

This invention was made with government support under 2022-33530-37118 awarded by National Institute of Food and Agriculture. The government has certain rights in the invention.

### FIELD

This disclosure relates to systems that can provide the necessary conditions to perform a reverse transcription reaction within a continuous flow channel of a microfluidics system.

### BACKGROUND

It has been theorized that a reverse transcription reaction can occur within a flow channel of a microfluidics device. Such reactions may increase the sensitivity and efficiency of RNA detection in microfluidic devices. For example, in US2019/0291114, Youngbull et al., the ability to perform reverse transcription was theorized to be possible in a continuously flowing system with the use of a thermocycler or a separate heating block. In WO2019/195197, which builds off the disclosure in US2019/0291114, describes a core heater element as a hollow cylinder. No other details about such a device were proffered in these disclosures as to how the construction and implementation of such a device may occur.

This invention strives to solve the problem of how to actually produce the conditions within a microfluidics device to achieve a reverse transcription reaction in a continuous flow system.

### SUMMARY

According to this disclosure, an embodiment of a system for the production of a reverse transcription reaction within a continuously flowing liquid may comprise a heating element that can be disposed on a thermal manifold, where it may have an upper surface and a lower surface, and can be structured and configured to disburse heat generated from the heating element which may produce a temperature profile to achieve a reverse transcription reaction. In such an embodiment there may also be a temperature detector, a temperature control that can be structured and configured to maintain the temperature profile, and a flow channel, wherein the flow channel can be structured and configured to be maintained within the temperature profile of the thermal manifold.

Such systems for the production of a reverse transcription reaction within a continuously flowing liquid may have a method of use that can comprise the following steps of providing a system for the production of a reverse transcription reaction within a continuously flowing liquid that can have a heating element disposed on a thermal manifold, where the thermal manifold can be structured and configured to disburse heat generated from the heating element that may produce a temperature profile which may achieve a reverse transcription reaction; such a provided system may also include a temperature detector, a temperature control that can be structured and configured to maintain the temperature profile; and a flow channel that can be maintained within the temperature profile. The method of use may also include the steps of generating a temperature profile within the thermal manifold, generating a reaction mixture that can be within a formulated liquid, flowing the formulated liquid into the flow channel at a first flow rate, exposing the reaction mixture to the first temperature profile; and flowing the formulated liquid out of the flow channel.

Such embodiments of methods of using systems for the production of a reverse transcription reaction within a continuously flowing liquid may also include a thermal manifold that can be structured and configured to be within a continuous-flow emulsion droplet reactor system between a reagent selection valve and an injection valve. Another embodiment of the method of using systems for the production of a reverse transcription reaction within a continuously flowing liquid may also include a thermal manifold that can be structured and configured to be within a continuous-flow emulsion droplet reactor system after an injection valve but before a droplet generator. Another embodiment of the method of using systems for the production of a reverse transcription reaction within a continuously flowing liquid may also include a thermal manifold that can be structured and configured to be within a continuous-flow emulsion droplet reactor system after a droplet generator but before other downstream reactions are implemented.

The Summary is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary as well as in the attached drawings and the Detailed Description, and no limitation as to the scope of the present invention is intended by either the inclusion or non-inclusion of elements, components, etc. in this Summary. Additional aspects of the present invention will become more readily apparent from the Detail Description, particularly when taken together with the drawings.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings.

FIG. 1 is a front-perspective view of an embodiment of a reverse transcriptase heater.

FIG. 2 is a cross-sectional view of the embodiment of FIG. 1.

FIG. 3 is a front-perspective view of an additional embodiment of a reverse transcriptase heater.

FIG. 4 is a partial representational diagram of a continuous flow system having a reverse transcriptase heater.

FIG. 5 is a partial representational diagram of a continuous flow system having a reverse transcriptase heater.

FIG. 6 is a partial representational diagram of a continuous flow system having a reverse transcriptase heater.

### DETAILED DESCRIPTION

The present disclosure relates to methods and apparatuses for a thermal manifold to produce a consistent temperature for the initiation of a reverse transcription reaction within a flow channel. Various embodiments are described in detail with reference to the drawings, in which reference numerals may be used to represent parts and assemblies throughout the several views. Reference to various embodiments does not limit the scope of the systems and methods disclosed herein. Examples of construction, dimensions, and materials may be illustrated for the various elements; those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient. Still, these are intended to cover applications or embodiments without departing from the disclosure's spirit or scope. Also, it is to be understood that the phraseology and terminology used herein are for the purpose of description and should not be regarded as limiting.

Reverse transcriptases are a broad family of enzymes used to generate complementary DNA (cDNA) from an RNA template; a process termed reverse transcription (RT). Optimal enzyme activity and maximum cDNA formation occur at a temperature range of 42°−48° C., but the reaction temperature can range from 25° C. to 58° C. The higher reaction temperature helps denature regions of strong RNA secondary structure, which can cause RTs to stall and limit cDNA size. Although high reaction temperatures can effectively resolve regions of strong secondary structures, these temperatures are detrimental to RNA integrity. In addition, RNA is thermolabile and can be susceptible to metal-catalyzed degradation. By conducting the RT inside a moving liquid (continuous flow/in-flow), under specific flow conditions and exposed to a particular temperature profile, it is possible to limit the production of undesired products and to improve the desired reaction efficiency. Furthermore, conducting in-flow RT enables the reaction to be incorporated into continuous-flow biosynthesis and analytical sensing processes.

A flow channel can be formed around a thermal manifold in which a specially formulated liquid can be sent through the channel and exposed to a temperature profile designed to achieve the RT reaction in the formulated liquid. The formulated liquid may, at a minimum, contain target RNA to be converted into cDNA and a reverse transcriptase enzyme. Commercially available formulations exist that may simply combine with an environmental sample.

In one embodiment, the formulated liquid can be of a type called ‘One-Step’ or ‘Single-Step’ formulation, which can include additional lysation, digestion, and/or stabilization enzymes. Such One-Step formulations have further benefit in-flow RT by allowing raw environmental water samples to be processed by RT and the reaction's cDNA product to be sent directly to additional analytical tools such as sequencers or PCR/qPCR/ddPCR instruments. In one embodiment, a tube can be wrapped around a thermal manifold, and the formulated reaction liquid may be pumped through the tube. This reaction can be kept in a continuous phase of a single flowing liquid, or in a discrete phase such as in a multifluid emulsion, segmented, or droplet flow. Alternatively, a tube may be wrapped around a thermal manifold, and a flow channel can be generated around or on the thermal manifold, for example, as a groove machined around a metal, or thermally conductive body or as a 3D printed channel in a thermally conductive body. A thermal manifold can mean a planar or 3-dimensional surface on which a temperature distribution is held. As the liquid flows across the manifold, it can thus be exposed to a specific temperature profile. The tube (or flow channel) dimensions and reaction liquid flow rate are such that the liquid can be maintained within a laminar flow regime, as exhibited by a low Reynolds number; for example, any Reynolds number below 2000. In some embodiments, the number of wraps that a tube (or flow channel) is wrapped about the thermal manifold can be a function of the flow rate and can be prescribed by the RT reaction time. Different RT enzymes can require different reaction times, thus necessitating a specific amount of wraps about the thermal manifold. Reaction times can be from ten minutes to over an hour.

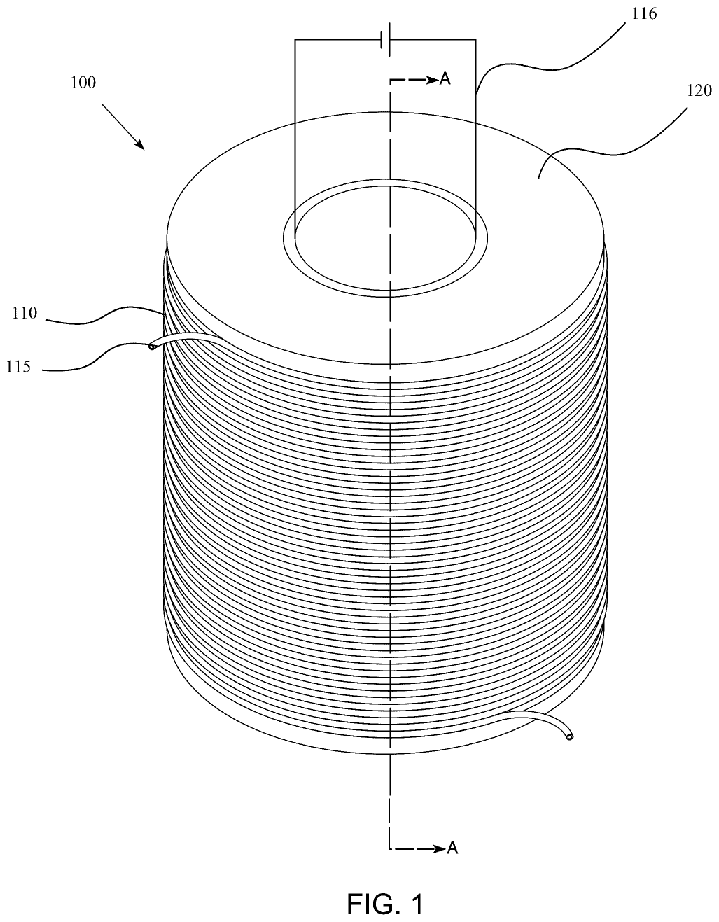

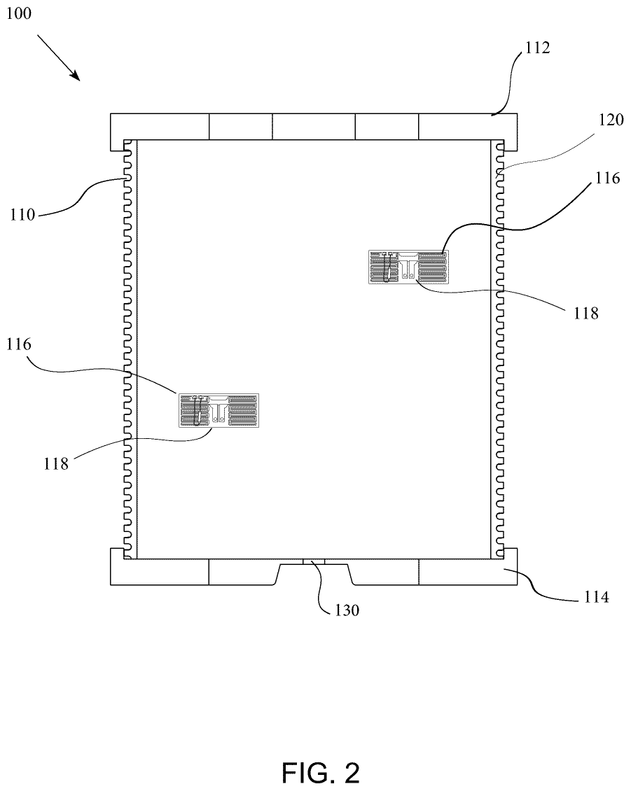

Regarding FIGS. 1 and 2, where an embodiment of a thermal manifold 100 includes a flow channel 110, which may be an integral portion of the cylindrical body 120; here, the flow channel 110 is comprised of a tube 115 that can be wrapped about the cylindrical body 120. The flow channel 110, in some embodiments, may be a fully enclosed groove machined within the body of the thermal manifold. In other embodiments, it may include a tube disposed within the machined grooves of the flow channel 110. The tube 115 may have an inner diameter that ranges from 0.001 inches to 0.125 inches. In the current embodiment of the thermal manifold 100, the inner diameter of 0.008 inches can be preferred to maintain laminar flow for the discrete phase and provide a reaction that can be in a single file. The outer diameter (OD) of an embodiment with a 0.008 inch inner diameter can be about 0.0625 inches; other ODs can vary in size. The number of times that the tube 115, of the flow channel 110, can be wrapped about the thermal manifold 100 may be prescribed by the reaction time required for a complete RT of the discrete phase and the flow rate of the discrete phase. The reaction time can range from as little as ten minutes to over an hour, depending on the reverse transcriptase enzyme; the system containing the thermal manifold may need to be optimized to different variants of the reverse transcriptase enzyme. The dimension of the cylindrical body 120 and the flow channel may be varied to further optimize the reaction time to perform more efficient RT reactions.

The temperature profile of the thermal manifold 100 can be generated with the use of a flexible-film heater 116 comprised of flexible tape combined with an embedded wire or a wire disposed thereon. For example, a Kapton® tape heater may be used as the flexible-film heater 116. Such flexible-film heaters 116 can be disposed on the interior of the cylindrical body 120 to evenly distribute the heat that the flexible-film heaters 116 yield. Other heaters may also satisfy the role of a heating element within the thermal manifold 100; for example, a thermoelectric heater may be used, or a hot-air blower. It may be desirable to maintain a tight temperature tolerance with about 0.1 degree Celsius variation to perform an efficient RT reaction. This tight temperature tolerance may be achieved with the use of a Resistance Temperature Detector 118 (“RTD”); other devices, such as a thermocouple, may be used, however, the RTD 118 may provide less variation. The RTD 118 may be connected to a proportional-integral-derivative controller (“PID”) (not shown); the PID, in conjunction with the RTD, may then further be integrated with the flexible-film heaters 116 to provide the desired temperature control. As illustrated in FIG. 2, the flexible-film heaters 116, RTD 118, and PID have been integrated with each other in this embodiment.

Other elements that may be included with the thermal manifold 100 to provide additional temperature control can be the upper surface 112 and the lower surface 114. The upper and lower surfaces may be connected to the cylindrical body 120 or disposed on to the opposite ends of the cylindrical body 120. The connection between the upper 112 and lower 114 surfaces and the cylindrical body 120 may include insulating foam, and the exteriors of the upper 112 and lower 114 surfaces may be wrapped with insulating thermal tape. The use of thermal tape may not be limited to the upper 112 and lower 114 surfaces. In some embodiments, thermal tape may be used to cover the tubing within the flow channel 110. To secure the thermal manifold 100 to a surface in order to maintain its position within a continuous flow system, a central connector may exist within the axis of the cylindrical body 120. For example, in FIG. 2, a hole 130 may be disposed within the lower surface 114; the hole 130 may also be coaxial to the cylindrical body 120.

FIG. 3 illustrates an alternative embodiment of a thermal manifold 200 where a flow channel 210 is disposed within a body 220. The flow channel 210 can be a tube 215 that may consist of a flow path within the body 220 that can provide the needed length of the tube 215 to accommodate the necessary reaction time and temperature to achieve the desired amount of RT for the production of cDNA. The body 220 may further include upper 212 and lower 214 surfaces, which may, in turn, comprise insulating foam. An integrated flexible-film heater 216, RTD 218, and PID can be disposed on a surface of the body 220 that will, in turn, allow control of the temperature profile necessary to perform RT.

A method of using the thermal manifold 100 may require the thermal manifold 100 to be integrated into a system that may include an emulsion droplet generator. Such a system may include a pump to drive the continuous flow and other peripheral devices. The system may include sample collectors where the collected samples may be combined with reverse transcriptase enzyme to produce the discrete phase of a formulated liquid that can flow through the flow channel 110 around the thermal manifold 100 to produce a reverse transcription reaction within the formulated liquid. The type of reverse transcriptase enzyme may need to be chosen for its ability to produce an efficient reaction with the temperature profile generated by the thermal manifold 100.

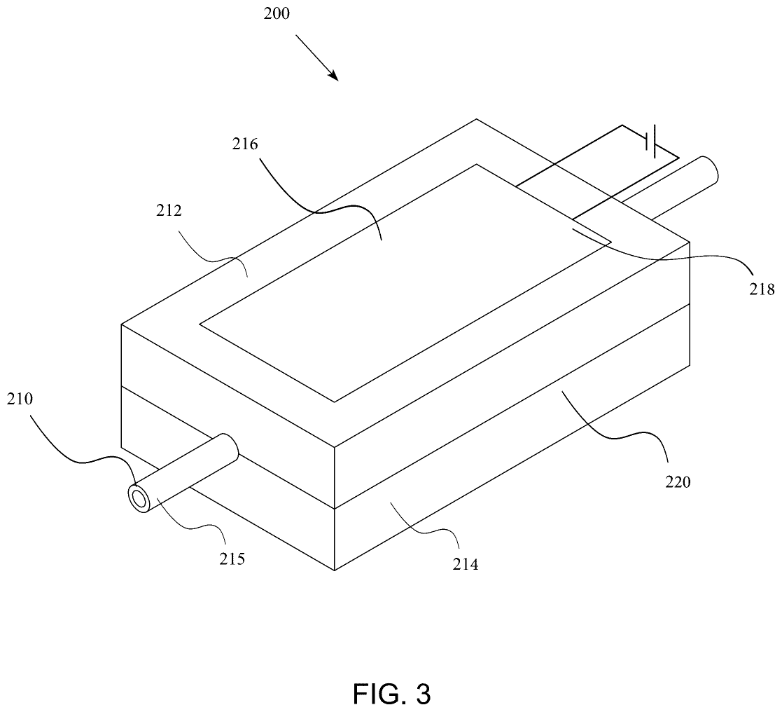

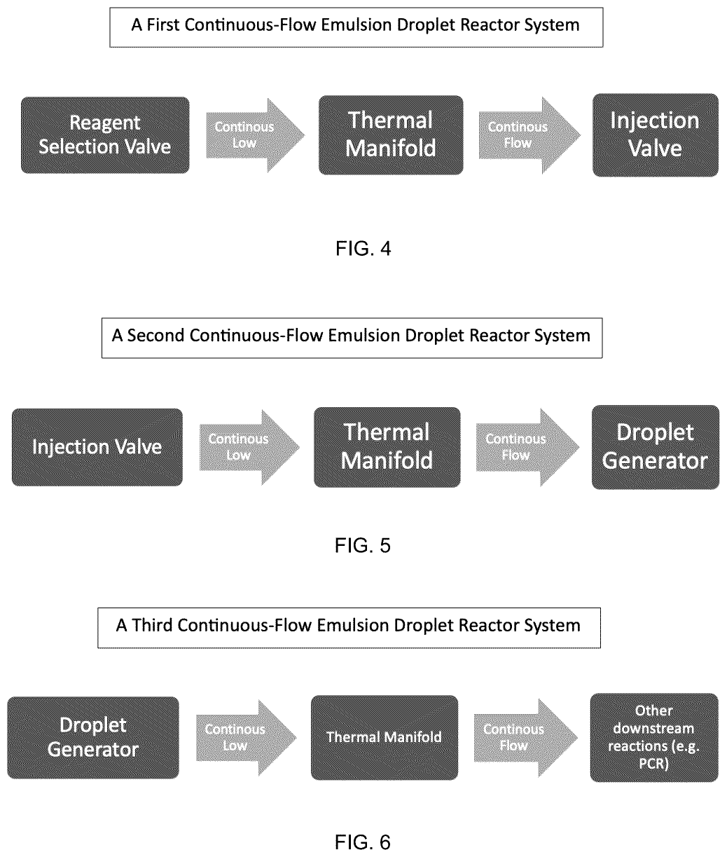

The thermal manifold 100, being a reverse transcription heater, can be placed in different locations within a continuous-flow emulsion droplet reactor system. As exemplified in the partial representation of a continuous-flow emulsion droplet reactor system of FIG. 4, a first location can be in a zone between a reagent selection valve and an injection valve. As exemplified in the partial representation of a continuous-flow emulsion droplet reactor system of FIG. 5, a second location for the placement of the thermal manifold 100 can be a zone that may be after an injection valve but before a droplet generator. As exemplified in the partial representation of a continuous-flow emulsion droplet reactor system of FIG. 6, a third location for the placement of the thermal manifold 100 can be a zone that is after a droplet generator but before other downstream reactions can be implemented, such as a Thermocycler used for PCR. Depending on where the thermal manifold is placed, the thermal manifold may take on different shapes and dimensions. In all cases, the reaction volume must be exposed to the specified RT reaction temperature for the time specified in an RT reaction protocol.

The thermal manifold may take on different shapes. The thermal manifold can be a thermally heated mass that can be in contact with a flow channel that contains an aqueous phase reaction of a formulated liquid. The diameter of the flow channel and the flow rate through that channel may dictate the dimensions and shape of the thermal manifold to ensure the entire reaction is contained in the heated zone for a time specified in an RT reaction protocol. If the flow channel is not simply linear but takes multiple turns in a plane, revolutions above a plane, or splits into multiple channels, the lateral dimensions and height profile of the thermal manifold can be modified so long as the entire volume of the RT reaction is exposed to the correct temperature for the correct time.

As was previously discussed, an embodiment of a thermal manifold can be placed in a second location. In such a location, where the thermal manifold can be after an injection valve, but before a droplet generator, the thermal manifold can be a heated metal cylinder with the flow channel comprising tubing can be wrapped around the thermal manifold. Insulation may then be placed around the tubing. In another embodiment, a thermal manifold can be placed in the second location, whereas in this embodiment, there can be greater flexibility in the flow rate. The reaction can be slowed (to a stop even) before Injection into a continuous-flow stream after the injection valve. So, the thermal manifold can be simplified into a rectangular block, just long enough to extend before and past the aqueous reaction volume in the flow channel comprising the tubing.

Persons of ordinary skill in arts relevant to this disclosure and subject matter hereof will recognize those embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is also intended to include features of a claim in any other independent claim, even if this claim is not directly made dependent on the independent claim.

We claim:

1. A system for the production of a reverse transcription reaction within a continuously flowing liquid comprising:
a heating element disposed on a thermal manifold;
the thermal manifold having an upper surface and a lower surface, wherein the thermal manifold is structured and configured to disburse heat generated from the heating element to produce a temperature profile to achieve a reverse transcription reaction;
a temperature detector;
a temperature control that is structured and configured to maintain the temperature profile; and
a flow channel, wherein the flow channel is structured and configured to be maintained within the temperature profile of the thermal manifold.

2. The system for the production of a reverse transcription reaction of claim 1, wherein the flow channel is integral to the thermal manifold.

3. The system for the production of a reverse transcription reaction of claim 1, wherein the flow channel comprises a tube.

4. The system for the production of a reverse transcription reaction of claim 1, wherein the heating element is a flexible-film heater.

5. The system for the production of a reverse transcription reaction of claim 1, wherein the temperature detector is a resistance temperature detector.

6. The system for the production of a reverse transcription reaction of claim 2, wherein a tube is disposed within the flow channel.

7. The system for the production of a reverse transcription reaction of claim 4, wherein the flexible-film heater is integrated with a proportional-integral-derivative controller, and a resistance temperature detector.

8. A method of use of a system for the production of a reverse transcription reaction within a continuously flowing liquid comprising:
providing a system for the production of a reverse transcription reaction within a continuously flowing liquid having:
a heating element disposed on a thermal manifold;
the thermal manifold, wherein the thermal manifold is structured and configured to disburse heat generated from the heating element to produce a temperature profile to achieve a reverse transcription reaction;
a temperature detector;
a temperature control that is structured and configured to maintain the temperature profile; and
a flow channel, wherein the flow channel is maintained within the temperature profile;
generating a temperature profile within the thermal manifold
generating a reaction mixture within a formulated liquid;
flowing the formulated liquid into the flow channel at a first flow rate;
exposing the reaction mixture to the first temperature profile; and
flowing the formulated liquid out of the flow channel.

9. The method of claim 8 wherein the temperature profile is a range of about 25° C. to about 58° C.

10. The method of claim 9 wherein the temperature profile is 42° C. to about 48° C.

11. The method of claim 8, wherein the first flow rate is a laminar flow, wherein the laminar has a low Reynolds number of about 2000 or less.

12. The method of claim 11, wherein the thermal manifold is structured and configured to be within a continuous-flow emulsion droplet reactor system between a reagent selection valve and an injection valve.

13. The method of claim 11, wherein the thermal manifold is structured and configured to be within a continuous-flow emulsion droplet reactor system after an injection valve but before a droplet generator.

14. The method of claim 11, wherein the thermal manifold is structured and configured to be within a continuous-flow emulsion droplet reactor system after a droplet generator but before other downstream reactions are implemented.

15. The method of claim 13, wherein the thermal manifold is a cylinder with the flow channel comprising a tube wrapped around the thermal manifold.

16. The method of claim 15, wherein the flow channel includes insulation disposed on the tubing.

17. The method of claim 13, wherein the first flow rate is adjustable to slow the flow of the formulated liquid.

18. The method of claim 17, wherein the thermal manifold comprises a rectangular block.
